(19) United States
(12) Patent Application Publication
(10) Pub. No.: US 2015/0142624 A1
(43) Pub. Date: May 21, 2015

(54) ADVANCE NOTICE AND ANALYSIS OF NOTICE DOCUMENTS FROM A TAXING AUTHORITY

(71) Applicant: HRB Innovations, Inc., Las Vegas, NV (US)

(72) Inventors: James L. Buttonow, Greensboro, NC (US); Ralph Bryan Howell, Browns Summit, NC (US); Brian Allen Howell, High Point, NC (US); Clay Andre Reimer, St John's (CA)

(21) Appl. No.: 14/548,589

(22) Filed: Nov. 20, 2014

Related U.S. Application Data
(60) Provisional application No. 61/907,223, filed on Nov. 21, 2013.

(51) Int. Cl. G06Q 40/00; H04L 29/06; G06Q 50/18

(52) U.S. Cl. CPC G06Q 40/123; G06Q 50/18; H04L 63/08
USPC 705/31

(57) ABSTRACT

A system and computerized method for receiving and analyzing a notice document from a taxing authority. A notice form data store has a plurality of notice forms associated therewith, each associated with at least one category. A taxpayer file data store has a plurality of taxpayer files associated therewith. An advance notice engine acquires the notice document associated with the taxpayer; analyzes the notice document by comparing the notice document to the notice forms associated with the notice form data store; analyzes the notice document by comparing the notice document to the taxpayer files associated with the taxpayer file data store; calculates a severity level and at least one category associated; and generates a notice information set based upon the severity level, the at least one category, and the notice document.

### RELATED APPLICATIONS

This non-provisional patent application claims priority benefit, with regard to all common subject matter, of earlier-filed U.S. Provisional Patent Application No. 61/907,223, filed on Nov. 21, 2013, and entitled “SYSTEM AND METHOD FOR RESPONDING TO NOTICE DOCUMENTS FROM A TAXING AUTHORITY.” The identified earlier-filed provisional patent application is hereby incorporated by reference in its entirety into the present application.

### BACKGROUND

1. Field

Embodiments of the invention relate to notice documents from a taxing authority. More specifically, embodiments of the invention relate to advance notice and analysis of notice documents coming from the taxing authority by an advance notice engine associated with a tax services provider.

2. Related Art

Tax authorities utilize notice documents to communicate with taxpayers. Notice documents inform the taxpayer of deficiencies, analyses, and warnings on tax-related topics. Previously, notice documents were sent directly to the taxpayer, regardless of whether the taxpayer self-prepared, utilized a tax services provider, or utilized a financial professional. This presented several problems, such as the taxpayer ignoring or overlooking the notice document, the taxpayer failing to properly respond to the notice document (if required), the taxpayer failing to notify the tax services provider or financial professional about the notice document, the taxpayer becoming upset or frightened because the notice document arrives without any further explanation or plan of action, the taxpayer leaving the services of the tax services provider or financial professional because of a perceived inadequacy of their services due to the notice document, etc. From the tax services provider's and/or financial professional's perspective, the problems include having a taxpayer describe the notice without being able to read the notice in full (or requesting that the taxpayer send a copy of the notice and then having to wait to receive it), having a reduced amount of time to respond to the notice document due to taxpayer delays, and having to expend personnel resources to analyze each individual notice document.

Taxing authorities, such as the Internal Revenue Service (IRS) of the United States, have begun accepting authorizations by the taxpayer for a taxpayer representative to receive notice documents in lieu of the taxpayer receiving the notice documents. For example, IRS Form 2848, as revised in July 2014, allows the taxpayer to appoint representatives and check a box labeled “Check if [the representative is] to be sent notices and communications.” By checking the box, the taxpayer is instructing the taxing authority that the representative can receive the notice documents. However, this is still an incomplete solution to the problem. Even with the taxing authority allowing the representative to receive the notice document, the prior art still lacks automation and analysis of the notice document. The representative (e.g., the tax services provider or the financial professional) must still physically read the notice and develop a plan of action manually. In addition, because the prior art does not provide any automation, many of the prior issues, such as the taxpayer becoming upset and confused by the notice document, remain unsolved.

### SUMMARY

Embodiments of the invention solve the above-mentioned problems by providing error checking of the authorization document; verification of acceptance by the taxing authority; association of the acceptance with the client file; scanning and keyword searches of the notice document; automated analysis of the notice documents; and generation of a notice information set to send to the client regarding the notice document along with a severity estimation, categorization, and a response plan. The taxpayer therefore receives the notice information set before, concurrently with, or slightly after receiving the notice document from the taxing authority. This reduces or eliminates the issues as found in the prior art.

Embodiments of the invention are generally directed to a system for receiving and analyzing a notice document from a taxing authority, the system comprising a notice form data store, a taxpayer file data store, and an advance notice engine. The notice form data store has a plurality of notice forms associated therewith, provided either by the taxing authority, by the tax services provider, or both. Each said notice form is associated with at least one category. The taxpayer file data store has a plurality of taxpayer files associated therewith. The advance notice engine performs the following steps: acquiring the notice document associated with the taxpayer; analyzing the notice document by comparing the notice document to at least a portion of the plurality of notice forms associated with the notice form data store; analyzing the notice document by comparing the notice document to at least a portion of the plurality of taxpayer files associated with the taxpayer file data store; calculating a severity level and at least one category associated with the notice document; and generating a notice information set based upon the severity level, the at least one category, and the notice document.

Embodiments of the invention are also generally directed to the advance notice engine. Yet further embodiments of the invention are directed to a computerized method for receiving and analyzing a notice document from a taxing authority, the method comprising the above-discussed steps.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 is a flow diagram illustrating an exemplary interaction via an advance notice engine between a tax professional, a taxpayer, and a taxing authority;

FIG. 2 is a flow diagram illustrating general steps of the method of an exemplary embodiment of the invention;

FIG. 3 is a flow diagram illustrating the correlation of a notice document with a notice form and a taxpayer;

FIG. 4 is a flow diagram illustrating the generation of a notice information set to assist in responding to the notice document; and

FIG. 5 is a system diagram of an embodiment of the invention depicting various computing devices and their components.

The drawing figures do not limit embodiments the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein.

Embodiments of the invention comprise a computer program, a method, and a system for providing advance notice and analysis of a notice document 10. Embodiments of the invention utilize an advance notice engine 12 to receive an authorization document 14, acquire notice documents 10, analyze the notice documents 10, generate a notice information set 16, and send the notice information set 16 to a taxpayer 18 and to an assigned tax professional 20 associated with the tax services provider.

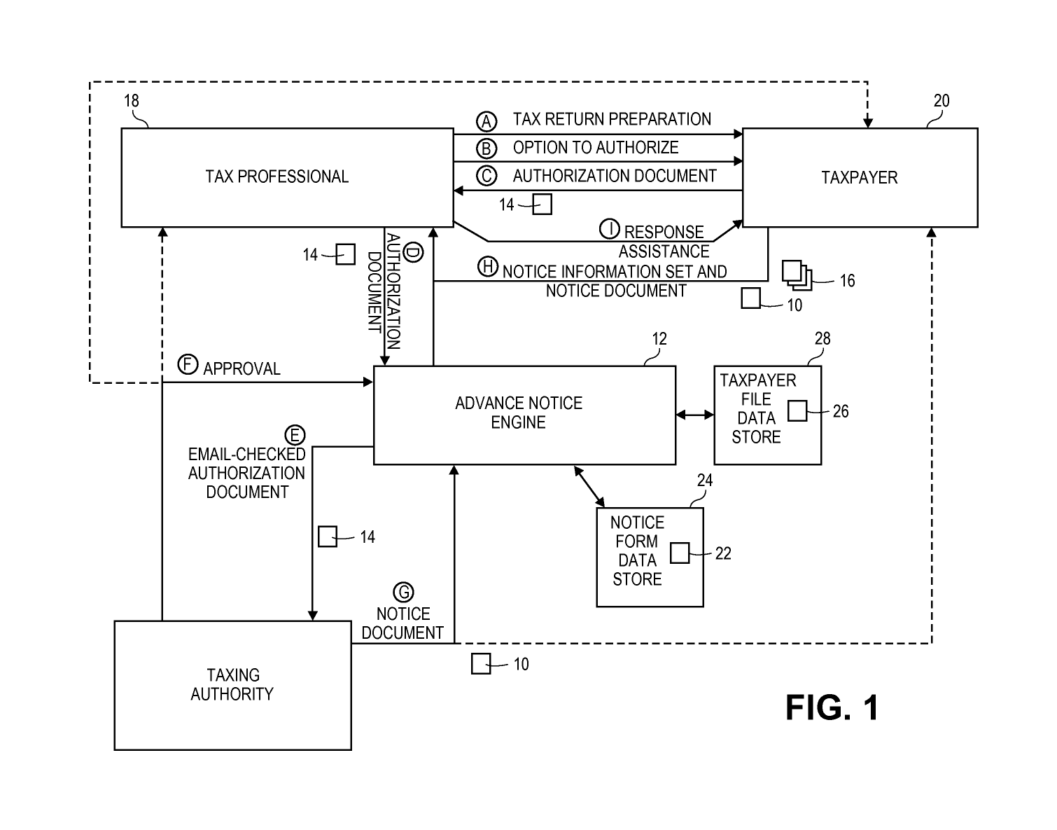

Turning to the figures, FIG. 1 is a flow diagram illustrating an exemplary interaction via the advance notice engine 12 between the tax professional 20, the taxpayer 18, and the taxing authority. The interaction begins in Step A, with the tax return preparation by the tax professional 20 for the taxpayer 18. In Step B, before, during, or after the tax return preparation, the tax professional 20 presents an option to the taxpayer 18 to authorize the tax services provider to receive notice documents 10 from the taxing authority in addition to them being received by the taxpayer 18. In Step C, the taxpayer 18 completes and signs the authorization document 14 and returns it to the tax professional 20. In Step D, the tax professional 20 submits the authorization document 14 to the advance notice engine 12, via scanning or electronically submitting an electronic copy. In Step E, the advance notice engine 12 validates the authorization document 14 and submits the error-checked authorization document 14 to the taxing authority. In Step F, the taxing authority approves the authorization document 14 and reports the approval to the advance notice engine 12. The taxing authority may alternatively or in addition report the approval to the tax services provider and/or the taxpayer 18. Upon the issuance of a notice document 10, in Step G the advance notice engine 12 receives or retrieves the notice document 10 from the taxing authority. The taxing authority may also send the notice document 10 to the taxpayer 18. In Step H, the advance notice engine 12 analyzes the notice document 10, as discussed in depth below, by accessing at least one notice form 22 from a notice form data store 24 and at least one taxpayer file 26 from a taxpayer file data store 28. Based upon the analysis, the advance notice engine 12 produces a notice information set 16 about the notice document 10 and sends the notice information set 16 to the taxpayer 18 and the tax services provider. In Step I, the tax professional 20 assists the taxpayer 18 in any necessary or recommended response to the notice document 10. It should be noted that, as in any other discussion of method steps described herein, the forgoing is an exemplary embodiment of the method and other embodiments of the method may comprise more or fewer steps, which could be out of order or simultaneous.

The taxpayer 18 includes any entity, either a legal or natural person, required by law to file a tax return with a government taxing authority, or to pay other taxes. Taxes to be paid can be United States Federal Income Tax, income tax for the various states within the United States, corporate taxes, partnership taxes, LLC taxes, property taxes, tariffs, or other taxes. Typically, the taxpayer 18 provides information relevant to themselves and the amount of tax owed in the form of the tax return. The tax return is discussed in more detail below.

It should be appreciated that although the entity receiving the notice document 10 is labeled herein a taxpayer, embodiments of the invention contemplate that any entity may receive notice documents 10. For example, if a person has never paid any federal income tax, he is still referred to herein as a ‘taxpayer.’ Similarly, a non-profit organization, which is under no federal requirement to pay taxes, may nonetheless be required to file documents with the taxing authority and may receive notice documents 10 from the taxing authority. The non-profit organization would still be referred to herein as a ‘taxpayer.’

The tax services provider includes any entity, either a legal person or natural person, or a computer program adapted to preparing taxes or providing other financial services. Examples of tax professionals include, but are not limited to, the following: a company, such as H&R Block, Inc.®, or an employee or agent of such a company; software adapted to prepare tax returns or other financial documents; and a person, legal or natural, who advises or assists the taxpayer 18 in preparing their own tax return. The tax services provider may also comprise a database for storing taxpayer files 26 and/or notice forms 22. In other embodiments, the notice form data store 24 is not associated with the tax services provider but is instead associated with the financial professional or the taxing authority. The tax professional may have an associated tax professional computing device, as discussed below. As referred to herein, a tax professional, a specific tax professional, or an assigned tax professional may refer to an individual natural person that is, is associated with, or is employed by the tax services provider. The tax professional 20 could also be a department or other sub-unit of the tax services provider. The tax professional 20 could also be the same entity as the tax services provider. The advance notice engine, as discussed herein, may be a portion of or otherwise associated with the tax services provider. In other embodiments, the advance notice engine is not associated with the tax services provider but does perform the described functions for the tax services provider because of a contractual relationship.

A financial professional (not illustrated) includes any entity, either a legal person or a natural person, or a computer program adapted to provide financial services or products. For example, the financial professional could be a financial advisor. By way of another example, the financial professional could be a website for monitoring the taxpayer's financial assets and liabilities. As another example, the financial professional could be a family member or attorney of the taxpayer 18 without any specialized financial training. The financial professional does not actually prepare, or assist in preparing, the tax return. Instead, the financial professional has access to a completed and/or filed tax return that was prepared by the taxpayer 18 or the tax professional 20. The financial professional may act on behalf of either the taxpayer 18 or the tax professional 20 in the discussed steps.

In embodiments of the invention, the tax services provider, tax professional 20, and/or financial professional are the same entity, or are employees of the same entity, or are otherwise associated with each other through, for example, a contractual or business relationship. In some embodiments, there is no financial professional involved. In other embodiments, there is no tax professional 20 involved, such as in an instance where the taxpayer 18 prepares their own tax return. As such, the terms “tax services provider,” “tax professional,” or “financial professional,” as used throughout, may denote any or all of these entities.

The taxing authority (also known as a revenue service, revenue agency, or taxation authority) is a government entity or an entity associated with a government body. The taxing authority has, through prescribed legal authority, the power to assess, levy, and collect taxes. The taxing authority may also have the power to collect other non-tax-related revenue, such as penalties and interest. The taxing authority may perform secondary functions, such as investigating and charging tax evasion, performing audits, etc. As discussed in depth below, the notice document 10 may be related to the collection of taxes, the collection of non-tax revenue, and/or the secondary functions of the taxing authority. The taxing authority can be at any level of government: international, federal, state, county, and city. Examples of taxing authorities include the IRS, the Missouri Department of Revenue, etc.

In other embodiments, the invention is directed to government entities other than taxing authorities, such as an administrative agency, or to companies or other organizations. The administrative agency may be associated with a government entitlement program, such as the Social Security Administration or Medicaid. The administrative agency may additionally, or in the alternative, be associated with a regulatory program, such as the Environmental Protection Agency or the Securities and Exchange Commission. The company or organization may be associated with or performing the functions of, a government entity, or it may be a for-profit or not-for-profit entity unrelated to the government. This government entity or company may issue notice documents, or their equivalent, that are handled and processed in the same manner as notice documents from a taxing authority.

In these embodiments, the “taxpayer” may instead be a “beneficiary,” a “citizen,” a “customer,” a “third party,” etc. While most of the present disclosure is directed to the field of taxes, this is only an exemplary field of use. For example, if the “taxing authority” is the Social Security Administration, then the “taxpayer” would be referred to as a “beneficiary.” This disclosure is therefore not intended to be limiting, but instead provide an easy-to-understand exemplary embodiment of the invention.

As used herein, “document” refers to a written message or information issued or prepared by the taxing authority pertaining to at least one taxpayer. The document can be a physical, printed copy of the message that is sent via the mail system. Additionally, or in the alternative, the document can be an electronic file containing text, structure, design, fonts, colors, and/or images. Additionally, or in the alternative, the document can be in any other format or medium that can be preserved and represented. The document may be privately or publicly available, secured (requiring computer authentication prior to display) or unsecured, and it may be a copy or an original. As defined in this paragraph, the document can refer to the notice document 10, the notice form 22, the authorization document 14, the authorization form, the tax return, tax-related documents, financial documents, the necessary response documents, etc.

The advance notice engine 12 receives information about the taxpayer 18. In one embodiment, the taxpayer 18 brings physical copies of his tax-related documents, such as W2s and 1099s, to the tax professional 20. The tax professional 20 then enters information from the tax-related documents into a tax preparation computer program. In another embodiment, the taxpayer 18 enters information from the tax-related documents into tax preparation software. The tax preparation computer program may be the same as or interface with the computer program of embodiments of the invention. In addition, the taxpayer 18 answers questions related to his taxes, either verbally to the tax professional 20 or by inputting into the computer program. At least a portion of the taxpayer information is stored in the taxpayer file data store 28 associated with the advance notice engine 12.

The tax return is a report filed with the appropriate taxing authority, such as the IRS in the case of U.S. federal income tax. Typically, the tax return contains information used to calculate the tax due. The tax return is commonly a form provided by the taxing authority, such as the Form 1040 provided by the IRS. However, the tax return could be on another type of form, a financial document, or other document. On the tax return, the taxpayer 18 or tax services provider calculates the taxes due. To assist in the calculation and to allow the taxing authority to verify the calculations, the tax return contains pertinent information associated with the taxpayer 18 for the tax year. The tax return can be either written, digital, or a combination of both. In other embodiments, information relevant to the taxpayer 18 and the tax to be paid are provided on other various forms and documents.

The set of taxpayer information that is received by the computer program comprises the tax return or information extracted from the tax return and other information associated with the taxpayer file 26. The set of taxpayer information may also include tax returns from previous years and/or relevant to other taxing authorities for the current and/or previous years, financial records, and bank statements. In yet other embodiments, the set of taxpayer information received by the computer program further comprises qualitative data, contact information, and/or demographic information of the taxpayer 18. In some embodiments, all of the information is received by the computer program as a single set. In other embodiments, the computer program may query the user to input additional information.

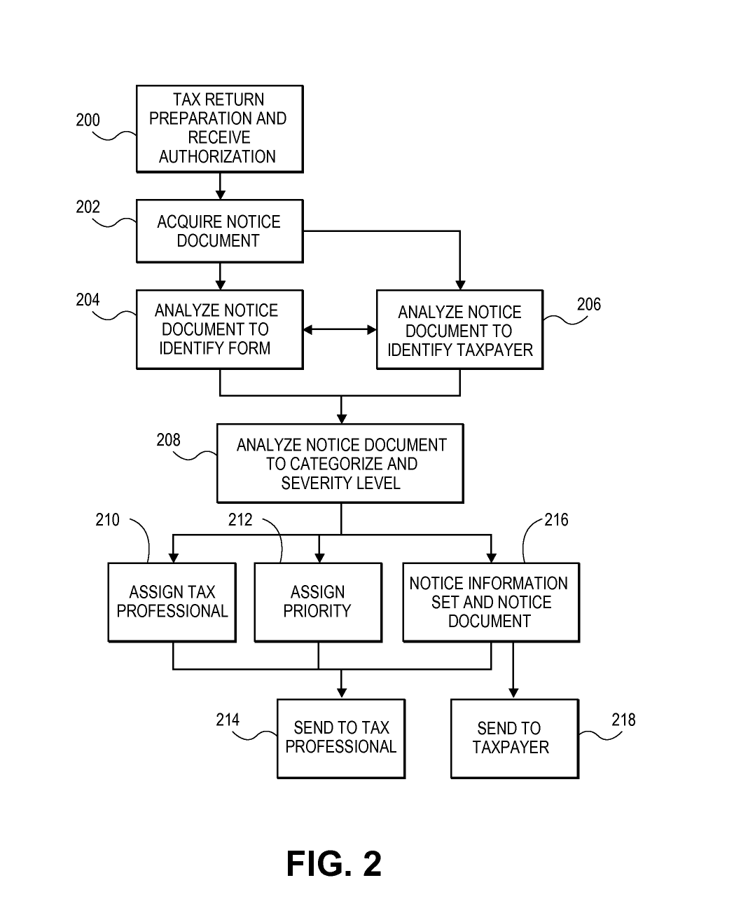

FIG. 2 presents a flow diagram illustrating general steps of one embodiment of the invention. Step 200 begins with tax preparation, or other financial services, performed by the tax services provider on behalf of the taxpayer 18. Before, during, or after the tax preparation, the taxpayer 18 is presented with an option to provide the tax services provider or financial professional with authorization to receive the notice documents 10 in addition to or in lieu of the taxpayer 18. Upon receiving the authorization document 14 from the taxpayer 18, some embodiments of the invention perform an automated error checking of the authorization document 14. The authorization document 14 is submitted to the taxing authority. The taxing authority accepts the authorization document 14. Some embodiments of the invention then actively monitor for the notice document 10. Upon receipt of a notification that a notice document 10 has been issued, or upon receipt of the notice document 10 itself, a digitized version of the notice document 10 is acquired in Step 202. In Step 204 the notice document 10 is analyzed to identify a notice form 22 within the notice form data store 24 that may correspond with the notice document 10. In Step 206, the notice document 10 is analyzed to identify the taxpayer or taxpayers 18 associated with the notice document 10. The notice document 10 is analyzed to gather information about it, such as an estimated severity level and a category in Step 208. Additionally, a specific tax professional 20 or financial professional may be assigned to assist the taxpayer 18 in responding to the notice document 10 in Step 210. In Step 212, the advance notice engine 12 may also assign or recommend a priority level for the tax professional 20 to respond to the notice document 10. In Step 214 this information is sent to the tax professional 20. In Step 216, a notice information set 16 is also generated, including, for example, information about the notice document 10, the estimated severity level, the category, the deadline for response (if required), forms or information for the response (if required), etc. In Step 218 the notice information set 16 and notice document 10 are submitted to the taxpayer 18 before, concurrently with, after, or instead of the taxpayer 18 receiving the notice document 10 from the taxing authority.

Before, during, or after the tax preparation, the taxpayer 18 is presented with the option to permit the tax services provider to receive notice documents 10 on behalf of the taxpayer 18, in Step 200. In other embodiments, an option to permit the financial professional to receive notice documents 10 on behalf of the taxpayer 18 is presented at a time unrelated to the filing of a tax return. For example, the taxpayer 18 may authorize the tax services provider or the financial professional to receive notice documents 10 following a first notice document received by the taxpayer 18. As another example, a financial professional who is a financial planner may present the option to the taxpayer 18 in the performance of his duties to oversee the financial situation of the taxpayer 18.

The option may be presented along with an authorization form (not illustrated). The authorization form may be provided by the taxing authority (such as Form 2848), or may be generated by the tax services provider or financial professional. The authorization form may also be partially or fully completed by the tax services provider or financial professional. For example, the tax professional's information and/or the taxpayer's information may be previously filled out. Additionally, certain boxes may be checked, such as the “Check if [the representative is] to be sent notices and communications” box on the Form 2848, and other information filled out. The option and the authorization form may be presented electronically, printed, or both (for example, the authorization may be electronic and then printed and signed by the taxpayer 18). The option and/or the authorization form may be presented along with legal statements, disclaimers, and other information about the benefits and risks of the program. When the taxpayer 18 completes the authorization form, it is thereafter referred to as the authorization document 14.

Contact information represents a method of reaching the taxpayer 18 or the tax services provider. The notice document 10 is sent to the taxpayer 18 and the tax services provider via the contact information. Therefore, the authorization document 14 contains the contact information. Much of the contact information is also listed on the tax return. The computer program or tax services provider may query the taxpayer 18 before, during, or after the tax preparation process to receive contact information. Examples of contact information include, but are not limited to, home address, work address, home phone number, cell phone number, e-mail address, and social media account, such as a FACEBOOK™ account or a TWITTER™ handle.

The advance notice engine 12 may then verify the authorization document 14, as illustrated in FIG. 1. The verification is done by performing an error check on the authorization form as completed. Error checking may include comparing the taxpayer information on the authorization form to taxpayer information on the current or previous tax returns. The error checking may also confirm that the tax professional's contact information. In other embodiments, other computer programs or persons perform the error checking.

If the authorization document 14 is approved, the advance notice engine 12 sends the authentication document to the taxing authority. The sending may be performed electronically, or via traditional mail. The advance notice engine 12 receives an acceptance or an acknowledgment of the authentication document from the taxing authority. This may be delayed, because the taxing authority may also verify the authentication document and/or because the taxing authority must approve the authorization document 14.

The advance notice engine may associate the authentication document and the approved status with the taxpayer file 26, as stored in the taxpayer file data store 28. Additionally, or in the alternative, the advance notice engine 12 may generate a listing of taxpayers for which the authorization document 14 has been approved by the taxing authority. The listing allows the advance notice engine 12 to more quickly and easily determine which taxpayer a new notice document corresponds to, as discussed below.

In Step 202, the advance notice engine 12 acquires the notice document 10. The advance notice engine 12 may monitor the taxing authority for new notice documents 10 related to the taxpayer 18. The advance notice engine 12 may additionally, or in the alternative, receive a notification that a notice document 10 has been issued. In some embodiments, the advance notice engine 12 receives an electronic communication, such as e-mail, indicative of a new notice document 10 being issued or sent to the taxpayer 18. The notice document 10 may be attached to the electronic communication, it may be in the body of the electronic communication, or it may indicate a way by which the tax services provider may acquire the notice document 10 (such as an electronic link to a website on which the notice document 10 can be found). Based upon the approved authorization document 14, the taxing authority also sends a notification to the taxpayer 18 as well as to the tax services provider and/or the financial professional at the respective contact information provided on the authorization document 14. In other embodiments, the tax preparer and/or financial professional receives a physical letter from the taxing authority through the mail. The physical notice document 10 may then be scanned or otherwise electronically input into the advance notice document 10, such as through optical character recognition (OCR).

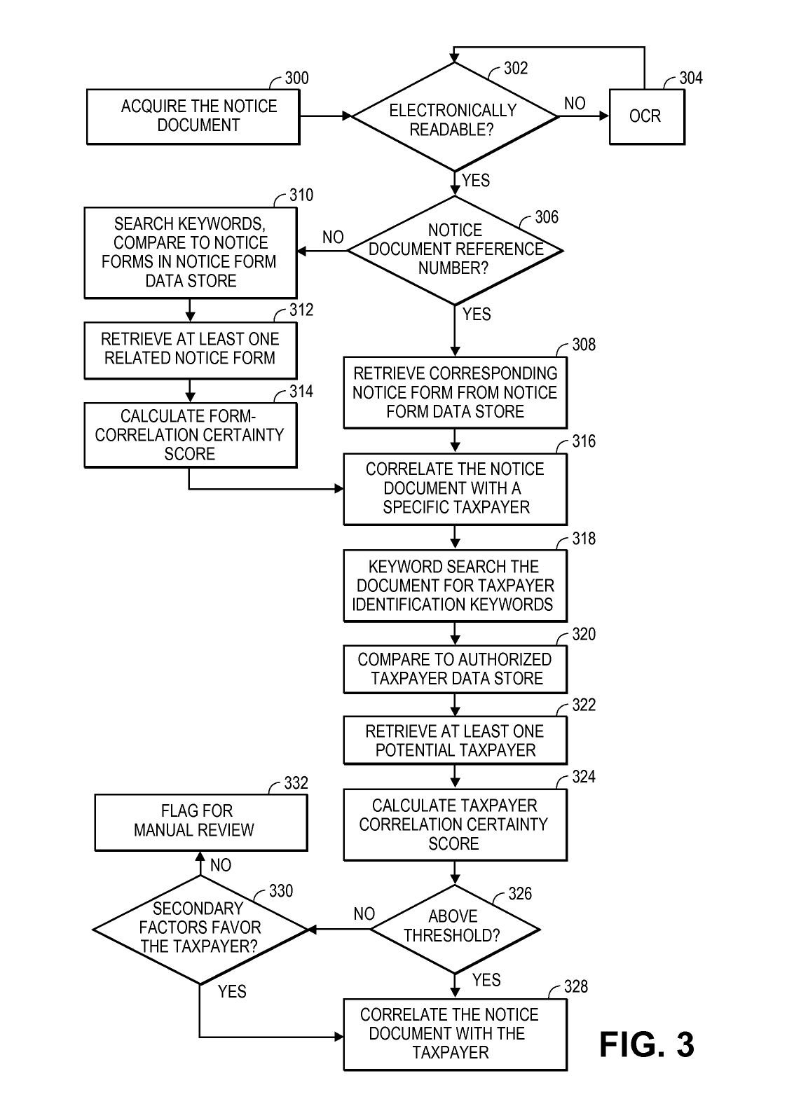

Turning to FIG. 3, the steps of the advance notice engine 12 regarding correlating the notice document 10 with at least one notice form 22 and at least one taxpayer 18 will now be discussed. In Step 300, the advance notice engine 12 receives or otherwise acquires the notice document 10. In Step 302, the advance notice engine 12 determines whether the notice document 10, as acquired, is electronically readable. The notice document 10 can be in an electronically searchable format, such as a ‘.doc’ or ‘.txt’ file, or the notice document 10 can be in an electronic non-searchable format, such as a non-searchable ‘.pdf’ or ‘.jpg’ file. For example, if the notice document 10 is provided in the electronic communication it may be easy for the advance notice engine 12 to read the contents. If, however, the notice document 10 is received as a physical letter, it may be scanned into the computer system via a scanner. The resultant scanned document may not be immediately searchable. If the advance notice engine 12 determines that the notice document 10 is not in an electronically readable format, the advance notice engine 12 (or associated computer function) may perform an optical character recognition in Step 304. Following the optical character recognition of Step 304, the advance notice engine 12 returns to Step 302 to determine again if the notice document 10 is in an electronically readable format. If the advance notice engine 12 determines that the notice document 10 is again in a non-computer readable format, it may produce an error and return the notice document 10 for human reading by a person associated with the tax services provider.

If the advance notice engine 12 determines that the notice document 10 is in an electronically readable format, the advance notice engine 12 begins analyzing the notice document 10. In Step 306, the advance notice engine 12 reads the notice document 10 to determine if there is a reference number assigned by the taxing authority. Many notice documents 10 are provided from the taxing authority with associated reference numbers that refer to the form on which the notice document 10 is based. As discussed below, the advance notice engine 12 is associated with, or access is provided to, a notice form data store 24 having a plurality of notice forms 22 therein, each with an associated reference number. If the advance notice engine 12 reads the notice document 10 and determines an associated reference number (Step 306), the advance notice engine 12 retrieves the corresponding notice form 22 from the notice form data store 24, in Step 308.

If, instead, the advance notice engine 12 reads the notice document 10 and fails to determine an associated reference number (Step 306), the advance notice engine 12 searches for a set of form-identification keywords in the notice document 10, and compares the found keywords to the notice forms 22 in the notice form data store 24, in Step 310. For example, the advance notice engine 12 may fail to determine an associated reference number due to an error in the optical character recognition. As another example, the advance notice engine 12 may fail to determine an associated reference number because there is no reference number in the notice document 10, such as in the case of an informal letter from the taxing authority, the case of a special notice document 10 to which no form reference number would correspond, or the case of a taxing authority which does not utilize or publish reference numbers. The above-mentioned set of form-identification keywords is based upon key terms to help identify the notice form 22. In addition, or in the alternative, the advance notice engine 12 may compare other aspects of the notice document 10 to the notice forms 22 in the notice form data store 24. These other aspects could include general layout, size and number of paragraphs, the presence or absence of tables or graphs, the presence or absence of bolded or underlined text, etc.

As the advance notice engine 12 compares the found keywords and/or other aspects of the notice document 10 to the plurality of notice forms 22 in the notice form data store 24, the advance notice engine 12 retrieves at least one potentially related notice form 22 in Step 312. For each such potentially related notice form, the advance notice engine 12 calculates a form-correlation certainty score in Step 314. The form-correlation certainty score may be expressed as a percentage or other grading, or a true/false value. If the form-correlation certainty score is true or relatively high (e.g., approximately 60%-100% probability of accuracy) for a certain retrieved notice form, the advance notice engine 12 may determine that the notice document 10 corresponds to the notice form 22. If the form-correlation certainty score is false or relatively low (e.g., approximately 0%-40% probability of accuracy) for each retrieved notice form, the advance notice engine 12 may determine that the notice document 10 does not correspond to any notice form in the notice form data store 24. For example, the notice form data store 24 may only include notice forms as issued by the IRS, while the received notice document 10 is from a state taxing authority. In this example, the advance notice engine 12 would determine that the notice document 10 is not in any of the IRS-issued notice forms, but would retrieve at least one related IRS-issued notice form to aid in the analysis of the notice document 10. If the form-correlation certainty score is in an intermediate range (e.g., approximately 40%-60% probability of accuracy), the determination may require review by a person associated with the advance notice engine 12.

In Step 316, the advance notice engine 12 determines the specific taxpayer 18 to which the notice document 10 correlates. As noted above, it should be appreciated that this step can be performed before, simultaneously with, or after the other discussed steps. The advance notice engine 12 determines the specific taxpayer 18 by analyzing the notice document 10 to determine a set of taxpayer-identification keywords, in Step 318. The taxpayer-identification keywords could include the name, social security number (or the last four digits thereof), zip code, etc. In Step 320, the advance notice engine 12 compares the set of taxpayer-identification keywords to the plurality of taxpayers for which the tax services provider has received authorization, as stored in the taxpayer file data store 28. In Step 322, the advance notice engine 12 identifies at least one taxpayer 18 for which the notice document 10 may correspond from the taxpayer file data store 28. In Step 324, the advance notice engine 12 calculates a taxpayer-correlation certainty score for each of the identified taxpayers. The advance notice engine 12 looks for matches and near matches in the spelling and numerals of the set of taxpayer-identification keywords and assigns values. For example, a last name match, four out of five digit zip code match, and a three out of four digit social security number match may calculate to a taxpayer-correlation certainty score that is true or relatively high (similar to the form-correlation certainty score). Inconsistencies in the set of taxpayer-identification keywords may be due to optical character recognition errors or typos by the taxing authority.

In Step 326, the advance notice engine 12 determines if the taxpayer-correlation certainty score is above a pre-set threshold. If the taxpayer-correlation certainty score is true or above the threshold, the advance notice engine 12 correlates the taxpayer 18 with the notice document 10 in Step 328. If the taxpayer-correlation certainty score is false or below the threshold, the advance notice engine 12 analyzes the notice document 10 and the taxpayer's file for secondary indications or factors in Step 330. One secondary indication may be whether the notice is applicable to the taxpayer 18. For example, if the taxpayer filed jointly then certain notice documents 10 may be ruled out as inapplicable to a jointly-filed tax return. As another example, a notice document 10 regarding business taxes may be ruled out as inapplicable to an individual taxpayer. As yet another example, notice documents 10 issued by a certain state taxing authority and alleging an error in a filed tax return may be ruled out for taxpayers who did not file a tax return in that state and do not live or work in that state. Another secondary indication may be whether the taxpayer 18 is expecting such a notice. For example, notices that are a certain sequential notice (such as a third notice of a deficiency) may be ruled out as inapplicable to a taxpayer who has not received the previous sequential notices (such as a first and second notice of the deficiency). Yet another secondary indication may be whether the taxpayer 18 has filed under another name. For example, if all information of the taxpayer 18 matches the notice document 10 save a last name, the advance notice engine 12 may analyze previous tax returns of the taxpayer 18 to determine if the last name was previously used by the taxpayer 18.

If the analysis of secondary indicators of Step 330 identified the taxpayer 18, the advance notice engine 12 correlates the notice document 10 with the taxpayer 18 in Step 328 (discussed above). If the analysis of secondary indicators of Step 330 fails to identify the corresponding taxpayer 18 for the notice document 10, the advance notice engine 12 may flag the notice document 10 for review by a person associated with the advance notice engine 12 in Step 332. In flagging the notice document 10 for review, the advance notice engine 12 may generate information for the person to review, such as notice document 10, a list of potentially corresponding taxpayers, the inconsistencies discovered with each potentially corresponding taxpayer, secondary indicators considered with each potentially corresponding taxpayer, etc. In other embodiments, the advance notice engine 12 associates the flag with the notice document 10 without any indication of potentially corresponding taxpayers.

Following the manual review, the person may instruct the advance notice engine 12 to associate the notice document 10 with a particular taxpayer 18. The person may also instruct the advance notice engine 12 to discard or destroy the notice document 10. For example, the person may do so if the notice document 10 was received in error or if the notice document 10 is in fact some other type of document.

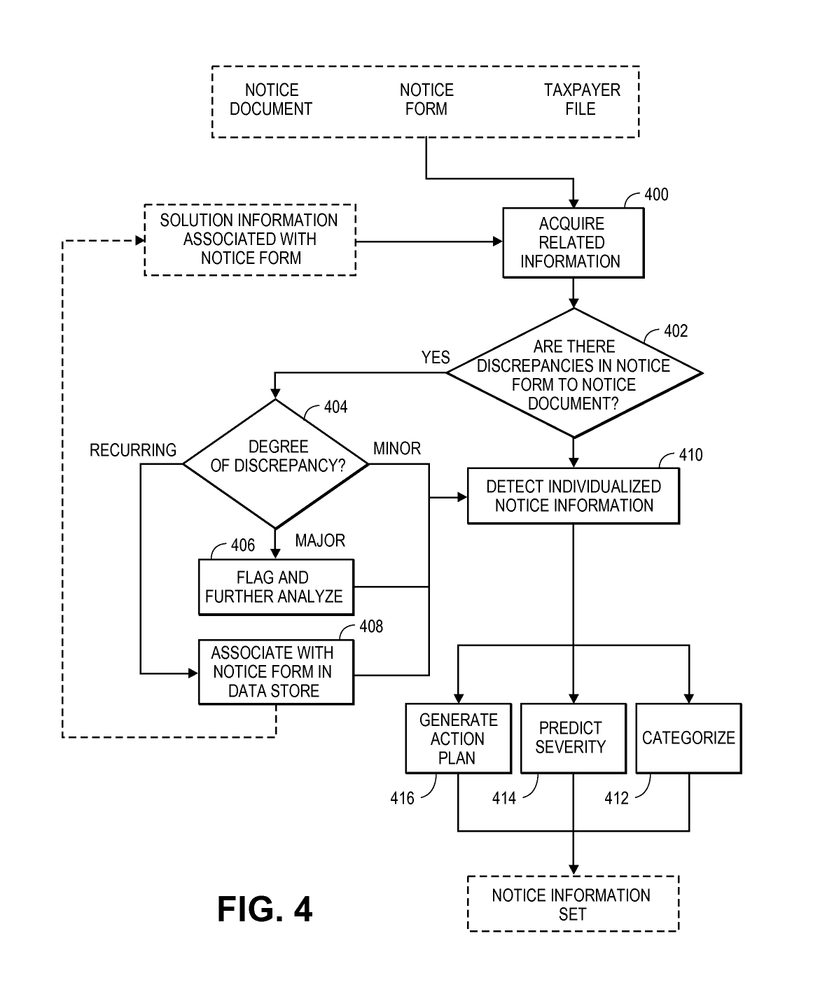

Turning to FIG. 4, the analysis of the notice document 10, the notice form 22, and the taxpayer 18 file to develop the notice information set 16 will now be discussed. In Step 400, the advance notice engine 12 retrieves solution information associated with the notice form 22 from the notice form data store 24. The solution information may include any or all of the following: background information on the notice form 22; an explanation of graphs, charts, and figures on the notice form 22; definitions for terms used in the notice form 22; information regarding whether a response is required or recommended; typical common characteristics of taxpayers who receive the notice form 22; information regarding the likely reason for the sending of the notice document 10; forms or example documents for any required or recommended response; testimonials regarding a prior experience with responding and dealing with the notice document 10, as submitted by taxpayers 18, tax professionals, and financial professionals; etc.

In Step 402, the advance notice engine 12 analyzes the notice document 10 and the notice form 22 to determine if there are discrepancies. Discrepancies are alterations or edits made to the notice document 10 that are not identical to the notice form 22. For example, the taxing authority may edit the notice form 22 when sending the notice document 10 to include stronger language or additional requirements for compliance. The advance notice engine 12 analyzes both documents to determine if discrepancies are present. In Step 404, the advance notice engine 12 determines the degree of the discrepancy. If the discrepancy is minor, for example a single character, the advance notice engine 12 may ignore or discard the discrepancy (e.g., because the discrepancy is likely caused by an OCR error) and continue to Step 410 (discussed below). If the discrepancy is large, for example an extra sentence at the end of a paragraph, the advance notice engine 12 may flag and/or further analyze the discrepancy, in Step 406.

In Step 408, the advance notice engine 12 may also record the discrepancy and associate it with the notice form 22, such that future instances will benefit from the information that was included in the prior discrepancy. If, for example, multiple future notice documents 10 contain the same or substantially similar discrepancy, the advance notice engine 12 may update the notice form 22 stored in the notice form data store 24 to include the discrepancy. The advance notice engine 12 would determine that the taxing authority has updated the notice form 22 and that all future notice documents 10 based upon that notice form can be expected to be in the updated form. The discrepancy may also be associated with the solution information for the notice form 22, as stored in the notice form data store 24.

In Step 410, the advance notice engine 12 analyzes the notice document 10 and the notice form 22 to determine the presence of individualized notice information. Examples of individualized notice information include name of the taxpayer 18, name of a representative of the taxpayer 18, contact information for the taxpayer 18, name of the tax services provider, contact information for the tax services provider, a date that the notice document 10 was issued, a date that the notice document 10 was mailed, a due date for responding to the notice document 10, a due date for complying with the requirements of the notice document 10, an amount owed, an interest amount charged on the amount owed, a name and contact information of a representative of the taxing authority assigned to handle the response, a name and contact information of a representative of the taxing authority who signed and sent the notice document 10, a listing of forms or documents missing or required, etc.

Based upon the found discrepancies and the individualized notice information, the advance notice engine 12 generates the notice information set 16. In Step 412, the advance notice engine 12 categorizes the notice document 10. The category may be based upon information in the solution information that was associated with the notice form 22. The category may also be based upon discrepancies discovered and the individualized notice information. For example, the category may be “business late fee notice” if the named taxpayer 18 on the notice document 10 is a business, even if the same notice form would be used for individual late fee notices. The category may also be based upon the sequential number of the notice document 10, for example, “Third Notice.” In some embodiments there are a plurality of assigned categories. These multiple categories could include the size and type of taxpayer (e.g., small business or middle-class individual), the sequential number of the notice document 10 (e.g., first notice), the alleged misconduct or failing (e.g., failure to file a tax return or failure to report income), or the threatened action by the taxing authority (e.g., levee on personal property or criminal prosecution). The advance notice engine 12 may then use the category to retrieve additional information about notice documents 10 in that category. For example, the advance notice engine 12 may retrieve information about responding to threatened criminal prosecution for all notice documents 10 that have such a category.

In Step 414, the advance notice engine 12 also predicts the severity level of the notice document 10. The severity level of the notice document 10 may be based upon several factors, including, for example, whether a response is required or recommended, the amount of time before the required response (based upon the due date and the current date), the amount of money at stake, the threatened punitive actions, the difficulty and complexity of the required response, the amount and degree of discrepancies between the notice form 22 and the notice document 10, or the size and type of taxpayer.

The severity level may change over time. For example, a notice document 10 requiring a simple form for a response may be initially assigned a low severity level. As the response due date approaches, the advance notice engine 12 may increase the severity level periodically. On the response due date, the advance notice engine 12 may assign the notice document 10 the highest severity level. In other embodiments, the severity level is static and determined, at least in part, by the notice form 22.

The advance notice engine 12 may also calculate an accuracy probability for the severity level. For example, for a notice document corresponding to a notice form requiring no response and with no discovered discrepancies, the advance notice engine 12 may calculate a low severity level and a high accuracy probability. As another example, if the notice document 10 corresponds to a notice form for which there are several possible response strategies and there are significant discrepancies, the advance notice engine 12 may calculate a moderate severity level and a low accuracy probability. Notice documents 10 associated with a low accuracy probability may be flagged for manual review, or may be associated with the notice document 10 for eventual review by the assigned tax professional (discussed below).

The advance notice engine 12 generates an action plan in Step 416. The action plan is a suggested or recommended response strategy and associated information. For example, if the notice document 10 is sent to a company notifying the company that it failed to file a tax return for the previous tax year, the action plan may include acquiring the necessary documents, preparing the tax return, and filing the tax return. If instead the company has been dissolved, the action plan may be to acquire supporting documents from the secretary of state in the state of formation, preparing a written response to the notice document 10, and filing the written response and the supporting documents with the taxing authority.

Because there may be situations and taxpayer desires for which the advance notice engine 12 may not have information, the action plan may include a plurality of courses of action. A course of action is a specific strategy that may be applicable in limited situations or an alternative method of responding to the notice document 10. For example, if the taxing authority is threatening to levee funds from the taxpayer's bank account to satisfy a debt, one course of action may be to file a petition with the taxing authority. A second course of action could be filing a lawsuit against the taxing authority seeking an injunction to stop the levee. A third course of action could be to negotiate a partial payment to temporarily prevent the levee. A fourth course of action could be to file for bankruptcy. The plan of action may include a recommended course of action along with a listing of all possible courses of action. The recommended course of action may be based upon the taxpayer's situation, as described in the taxpayer file 26. In other embodiments, there is no recommended course of action assigned by the advance notice engine 12. The tax professional 20 reviewing the file may recommend a course of action.

As generally illustrated in FIG. 4, the advance notice engine 12 compiles at least a portion of the category, the predicted severity, and the generated action plan into the notice information set 16. The notice information set 16 may be in the form of an electronic message. The notice information set 16 may be in a format that is easy to read and understand by the taxpayer 18. For example, the notice information set 16 may include introductory paragraphs from the solution information associated with the notice form 22.

Returning to FIG. 2, the advance notice engine 12 assigns a tax professional 20 (Step 210) and assigns a priority to the notice document 10 (Step 212). The advance notice engine 12 also sends these items to the tax professional 20 (Step 214) along with the notice information set 16 and the notice document 10 (Step 216). The notice information set 16 and notice document 10 are sent to the taxpayer 18 in Step 218.

In Step 210, the advance notice engine 12 assigns a tax professional 20 to be responsible for the notice document 10. The advance notice engine 12 may assign a specific tax professional 20 or a certain division or department within or associated with the tax services provider. The responsibilities as to the notice document 10 and its response may be laid out in the notice information set 16. In some embodiments, the default tax professional 20 is one that the taxpayer 18 previously dealt with. For example, if the tax professional 20 that assisted the taxpayer 18 in preparing the tax return is still associated with the tax services company, qualified to handle the response, and available to complete the responsibilities, the advance notice engine 12 may assign that tax professional 20 to handle the response. In some instances, such as a notice document that has been assigned a low severity and no required response, there may be no assigned tax professional. Instead, the notice document 10 and notice information set 16 may be associated with the taxpayer file 26 with no further action taken. If the tax professional is unavailable, the advance notice engine 12 may assign that tax professional's supervisor or another tax professional based upon a number of factors (such as geographic proximity to the taxpayer 18, the tax professional's work load, the tax professional's handling of previous notice documents 10, etc.).

If the notice document 10 has been assigned a high severity level and/or is assigned a certain category, the advance notice engine 12 may assign a tax professional or department that specializes in that category and/or severity level. For example, the tax services company may have a department that deals with levees and garnishments, such that notice documents 10 dealing with levees and garnishments may be assigned to that department. As another example, the levees and garnishments department may be assigned all notice documents 10 that are a third sequential notification regarding a levee or garnishment. In some embodiments and as another example, notice documents 10 with discrepancies may be assigned to tax professionals that deal with such discrepancies.

In Step 212, the advance notice engine 12 assigns or recommends a priority to the notice document 10. The advance notice engine 12 may acquire information as to the other notice documents and workload for the tax professional 20. The advance notice engine 12 may then assign a priority to the notice document 10 based upon the workload. Notice documents 10 that are flagged for manual review or assigned a high severity are placed at or near the top of a work queue for the tax professional 20. For example, a notice document that require a response within two days may be prioritized by the advance notice engine 12 to the top of the work queue regardless of severity level. Information regarding the assignment and the priority are sent to the assigned tax professional 20 in Step 214.

In Steps 216 and 218 at least a portion of the notice information set 16 is sent to the taxpayer 18. Some portions of the notice information set 16 may include proprietary information, source code, non-recommended courses of action, technical jargon, and other information that may be unsuitable for the taxpayer 18 to receive. The advance notice engine 12 may filter this information out, or may select only the information relevant to the taxpayer to be sent to the taxpayer 18. The notice document 10 may be sent to the taxpayer 18 in lieu of or in addition to the taxing authority sending the notice document 10 to the taxpayer 18. In some embodiments, the advance notice engine 12 receives an electronic version of the notice document 10, performs the described analyses, and submits the notice information set 16 and the notice document 10 to the taxpayer 18 before (or substantially shortly after) the taxpayer 18 receives the notice document 10 from the taxing authority.

A system of embodiments of the invention will now be discussed. The system may comprise computing devices to facilitate the functions and features described herein. The computing devices may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system.

The advance notice engine 12, as described above, may be implemented in any single, or any combination of the below-described hardware. The advance notice engine 12 may therefore have at least one associated processing element, at least one associated memory element, at least one associated communications element, etc. The advance notice engine 12 may be a special-purpose device, adapted to perform the above-described steps. In other embodiments, the advance notice engine 12 is a computer program that operates on a generic computing device (such as a server) and in operation becomes a special-purpose computing device. The advance notice engine 12 improves the functionality of the computing device by automatically analyzing the notice document 10 and providing information to a user, instead of displaying the notice document 10 and forcing the user to perform the analysis (such as by accessing the notice form data store 24 to retrieve a corresponding notice form 22). The advance notice engine 12 performs the described steps prior to the presentation of the notice document 10. As such the notice document 10 is presented along with the notice information set 16, which allows the user to immediately access the notice information set 16 while reading (or prior to reading) the notice document 10. This function could not be performed by a human.

The notice form data store 24 and the taxpayer file data store 28 may be individual databases each associated with the advance notice engine 12 or they may each be co-located within the same database. Each may also be composed of a single or a plurality of computing devices. In other embodiments, the advance notice engine 12, the notice form data store 24, and the taxpayer file data store 28 are all associated with the same computing device. In still other embodiments, the advance notice engine 12 and the notice form data store 24 are associated with the same computing device, while the taxpayer file data store 28 is associated with a plurality of computing devices remotely located away from the advance notice engine 12 and the notice form data store 24.

The system may also comprise a tax professional computing device communicatively coupled with the advance notice engine 12. The tax professional computing device has an associated non-transitory computer readable storage medium with a computer program stored thereon, wherein execution of the computer program by at least one processing element performs functions as described herein as being performed by the tax services provider and/or tax professional 20. These functions could include preparing a tax return, submitting a tax return to the taxing authority, presenting the taxpayer 18 with an option to authorize, providing for the taxpayer 18 the authorization document 14, receiving the completed authorization document 14, sending the authorization document 14 to the advance notice engine 12, receiving a notification that the taxing authority has accepted and/or approved the authorization document 14, receiving the notice document 10 from the taxing authority and/or the advance notice engine 12, receiving the notice information set 16 from the advance notice engine 12, etc. The tax professional computing device may also perform case management functions to assist the tax professional 20 with assisting the taxpayer 18 in responding to the notice document 10, such as providing reminders, automatically completing at least a portion of the response document, adjusting the priority based upon the workload and approaching due dates, etc. In some embodiments, the tax professional computing device is co-located and associated with the advance notice engine 12, the notice form data store 24, and/or the taxpayer 18 file data store.

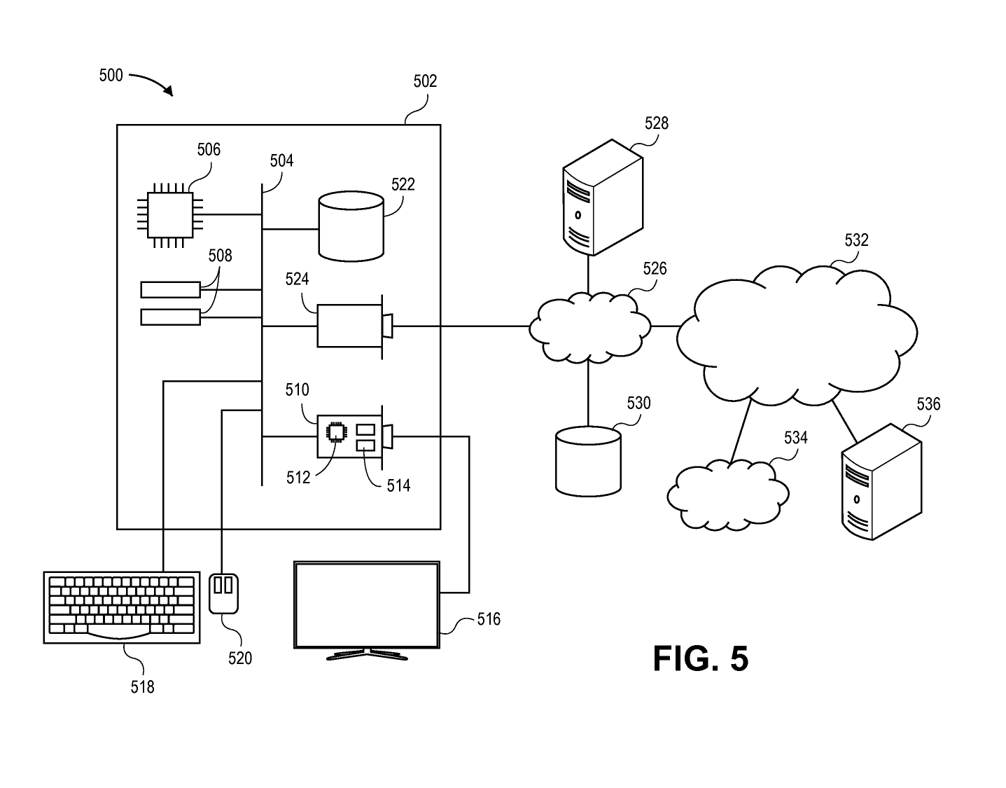

Turning to FIG. 5, the system 500 comprising an exemplary hardware platform that can form one element of certain embodiments of the invention is depicted. Computer 502 can be a desktop computer, a laptop computer, a server computer, a mobile device such as a smartphone or tablet, or any other form factor of general- or special-purpose computing device. Depicted with computer 502 are several components, for illustrative purposes. In some embodiments, certain components may be arranged differently or absent. Additional components may also be present. Included in computer 502 is system bus 504, whereby other components of computer 502 can communicate with each other. In certain embodiments, there may be multiple busses or components may communicate with each other directly. Connected to system bus 504 is central processing unit (CPU) 506. Also attached to system bus 504 are one or more random-access memory (RAM) modules 508.

Also attached to system bus 504 is graphics card 510. In some embodiments, graphics card 504 may not be a physically separate card, but rather may be integrated into the motherboard or the CPU 506. In some embodiments, graphics card 510 has a separate graphics-processing unit (GPU) 512, which can be used for graphics processing or for general purpose computing (GPGPU). Also on graphics card 510 is GPU memory 514. Connected (directly or indirectly) to graphics card 510 is display 516 for user interaction. In some embodiments no display is present, while in others it is integrated into computer 502. Similarly, peripherals such as keyboard 518 and mouse 520 are connected to system bus 504. Like display 516, these peripherals may be integrated into computer 502 or absent. Also connected to system bus 504 is local storage 522, which may be any form of computer-readable media, and may be internally installed in computer 502 or externally and removably attached.

Finally, network interface card (NIC) 524 is also attached to system bus 504 and allows computer 502 to communicate over a network such as network 526. NIC 524 can be any form of network interface known in the art, such as Ethernet, ATM, fiber, Bluetooth, or Wi-Fi (i.e., the IEEE 802.11 family of standards). NIC 524 connects computer 502 to local network 526, which may also include one or more other computers, such as computer 528, and network storage, such as data store 530. Local network 526 is in turn connected to Internet 532, which connects many networks such as local network 526, remote network 534 or directly attached computers such as computer 536. In some embodiments, computer 502 can itself be directly connected to Internet 532.

The computer program of embodiments of the invention comprises a plurality of code segments executable by the computing device for performing the steps of various methods of the invention. The steps of the method may be performed in the order discussed, or they may be performed in a different order, unless otherwise expressly stated. Furthermore, some steps may be performed concurrently as opposed to sequentially. Also, some steps may be optional. The computer program may also execute additional steps not described herein. The computer program, system, and method of embodiments of the invention may be implemented in hardware, software, firmware, or combinations thereof using the system 500, which broadly comprises server devices, computing devices, and communication networks.

The computer program of embodiments of the invention may be responsive to user input. As defined herein user input may be received from a variety of computing devices including but not limited to the following: desktops, laptops, calculators, telephones, smartphones, or tablets. The computing devices may receive user input from a variety of sources including but not limited to the following: keyboards 518, keypads, mice 520, trackpads, trackballs, pen-input devices, printers, scanners, facsimile, touchscreens, network transmissions, verbal/vocal commands, gestures, button presses or the like.

The server devices and computing devices may include any device, component, or equipment with at least one processing element and at least one memory element. The processing element may implement operating systems, and may be capable of executing the computer program, which is also generally known as instructions, commands, software code, executables, applications (“apps”), and the like. The at least one processing element may comprise processors, microprocessors, microcontrollers, field programmable gate arrays, and the like, or combinations thereof. The at least one memory element may be capable of storing or retaining the computer program and may also store data, typically binary data, including text, databases, graphics, audio, video, combinations thereof, and the like. The at least one memory element may also be known as a “computer-readable storage medium” and may include random access memory (RAM) 508, read only memory (ROM), flash drive memory, floppy disks, hard disk drives, optical storage media such as compact discs (CDs or CDROMs), digital video disc (DVD), and the like, or combinations thereof. In addition to the at least one memory element, the server devices may further include file stores comprising a plurality of hard disk drives, network-attached data store 530, or a separate storage network.

The computing devices may specifically include mobile communication devices (including wireless devices), work stations, desktop computers, laptop computers, palmtop computers, tablet computers, portable digital assistants (PDA), smart phones, and the like, or combinations thereof. Various embodiments of the computing device may also include voice communication devices, such as cell phones and/or smart phones. In preferred embodiments, the computing device will have an electronic display 516 operable to display visual graphics, images, text, etc. In certain embodiments, the computer program facilitates interaction and communication through a graphical user interface (GUI) that is displayed via the electronic display 516. The GUI enables the user to interact with the electronic display 516 by touching or pointing at display areas to provide information to the system.

The communication network may be wired or wireless and may include servers, routers, switches, wireless receivers and transmitters, and the like, as well as electrically conductive cables or optical cables. The communication network may also include local, metro, or wide area networks, as well as the Internet 532, or other remote networks 532. Furthermore, the communication network may include cellular or mobile phone networks, as well as landline phone networks, public switched telephone networks, fiber optic networks, or the like.

The computer program may run on computing devices or, alternatively, may run on one or more server devices. In certain embodiments of the invention, the computer program may be embodied in a stand-alone computer program (i.e., an “app”) downloaded on a user's computing device or in a web-accessible program that is accessible by the user's computing device via the communication network. As used herein, the stand-along computer program or web-accessible program provides users with access to an electronic resource from which the users can interact with various embodiments of the invention.

In embodiments of the invention, users may be provided with different types of accounts. Each type of user account may provide their respective users with unique roles, capabilities, and permissions with respect to implementing embodiments of the invention. For instance, the taxpayer 18 may be provided with a taxpayer account that permits the taxpayer 18 to access embodiments of the invention that are applicable to authorizing the tax services provider to receive notice documents 10, reviewing received notice documents 10 and notice information sets, etc. Additionally, the tax professional 20 or financial professional may be provided with a tax professional account or financial professional account, respectively, through which he can monitor notice documents 10, plans of action, and report statuses. In addition, any number and/or any specific types of account are provided to carry out the functions, features, and/or implementations of the invention. Upon the taxpayer 18, third party, tax professional 20, and/or financial professional logging in to the electronic resource for a first time, they may be required to provide various pieces of identification information to create their respective accounts. Such identification information may include, for instance, personal name, business name, email address, phone number, or the like. Upon providing the identification information, the taxpayer 18, third party, and/or tax professional 20 may be required to enter (or may be given) a username and password, which will be required to access the electronic resource.

Although embodiments of the invention have been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for receiving and analyzing a notice document from a taxing authority, the system comprising:
a notice form data store having a plurality of notice forms associated therewith, wherein each said notice form is associated with at least one category;
a taxpayer file data store having a plurality of taxpayer files associated therewith; and
an advance notice engine having an associated non-transitory computer readable storage medium with a computer program stored thereon, wherein execution of the computer program by at least one processing element performs the following steps:
acquiring the notice document associated with the taxpayer;
analyzing the notice document by comparing the notice document to at least a portion of the plurality of notice forms associated with the notice form data store;
analyzing the notice document by comparing the notice document to at least a portion of the plurality of taxpayer files associated with the taxpayer file data store;
calculating a severity level and at least one category associated with the notice document; and
generating a notice information set based upon the severity level, the at least one category, and the notice document.

2. The system of claim 1, wherein the notice form data store and the taxpayer file data store are associated with the advance notice engine.

3. The system of claim 1, wherein the notice form data store is associated with a computing device communicatively coupled with the advance notice engine.

4. The system of claim 1, wherein each said notice form is associated with a severity level.

5. The system of claim 1, wherein acquiring the notice document includes receiving a scanned image of a printed version of the notice document sent from the taxing authority.

6. The system of claim 1, wherein acquiring the notice document includes receiving a notification that a notice document has been issued by the taxing authority and retrieving the notice document form the taxing authority.

7. The system of claim 1, wherein acquiring the notice document includes determining if the notice document is in an electronically readable format and, if not, performing an optical character recognition on at least a portion of the notice document.

8. The system of claim 1, wherein analyzing the notice document includes identifying at least one keyword on the notice document that is indicative of the category.

9. The system of claim 1, wherein execution by the computer program further comprises the step of assigning a tax professional associated with the tax services provider to assist the taxpayer in responding to the notice document.

10. The system of claim 1, wherein execution by the computer program further comprises the step of sending the notice document and at least a portion of the notice information set to the taxpayer.

11. The system of claim 1, the system further comprising:
a tax professional computing device communicatively coupled with the server, the tax professional computing device having an associated non-transitory computer readable storage medium with a computer program stored thereon, wherein execution of the computer program by at least one processing element performs the following steps:
receiving, from the advance notice engine, the notice information set;
receiving, from the advance notice engine, a notification that the advance notice engine has assigned a certain tax professional to handle responding to the notice document; and
receiving, from the advance notice engine, a priority for responding to the notice document;

12. The system of claim 1, wherein the computer program further performs the following steps:
receiving an authorization document indicative of a taxpayer authorizing a tax services provider to have access to the notice document;
analyzing the authorization document to determine if the authorization document is free of errors,
transmitting the authorization document to the taxing authority; and
receiving, from the taxing authority, an indication that the authorization document has been accepted by the taxing authority.

13. The system of claim 12, wherein the computer program further performs the step of associating the authorization document with the taxpayer file in the taxpayer file data store.

14. The system of claim 12, wherein the analyzing the authorization document is performed, at least in part, by comparing the authorization document to a set of taxpayer data for the taxpayer.

15. An advance notice engine for receiving and analyzing a notice document from a taxing authority, having an associated non-transitory computer readable storage medium with a computer program stored thereon, wherein execution of the computer program by at least one processing element performs the following steps:
acquiring the notice document associated with the taxpayer;
analyzing the notice document by comparing the notice document to at least a portion of a plurality of notice forms associated with a notice form data store;
analyzing the notice document by comparing the notice document to at least a portion of a plurality of taxpayer files associated with a taxpayer file data store;
calculating a severity level and at least one category associated with the notice document; and
generating a notice information set based upon the severity level, the at least one category, and the notice document.

16. The advance notice engine of claim 15, wherein the computer program further performs the following steps:
receiving an authorization document indicative of a taxpayer authorizing a tax services provider to have access to the notice document;
analyzing the authorization document to determine if the authorization document is free of errors,
transmitting the authorization document to the taxing authority; and
receiving, from the taxing authority, an indication that the authorization document has been accepted by the taxing authority.

17. The advance notice engine of claim 15, wherein analyzing the notice document includes identifying at least one keyword on the notice document that is indicative of the category.

18. The advance notice engine of claim 15, wherein execution by the computer program further comprises the step of assigning a tax professional associated with the tax services provider to assist the taxpayer in responding to the notice document.

19. The advance notice engine of claim 15, wherein execution by the computer program further comprises the step of sending the notice document and at least a portion of the notice information set to the taxpayer.

20. A computerized method for receiving and analyzing a notice document from a taxing authority, the steps of the method comprising:
acquiring the notice document associated with the taxpayer;
analyzing the notice document by comparing the notice document to at least a portion of the plurality of notice forms associated with the notice form data store;
analyzing the notice document by comparing the notice document to at least a portion of the plurality of taxpayer files associated with the taxpayer file data store;
calculating a severity level and at least one category associated with the notice document; and
generating a notice information set based upon the severity level, the at least one category, and the notice document.
